(19) United States
(12) Patent Application Publication
(10) Pub. No.: US 2015/0215101 A1
(43) Pub. Date: Jul. 30, 2015

(54) WIRELESS COMMUNICATION APPARATUS AND WIRELESS COMMUNICATION METHOD

(71) Applicant: KABUSHIKI KAISHA TOSHIBA, Tokyo (JP)

(72) Inventors: Tomoya TANDAI, Ota Tokyo (JP); Ryoko MATSUO, Shinagawa Tokyo (JP); Tomoko ADACHI, Kawasaki Kanagawa (JP); Tsuyoshi KOGAWA, Kawasaki Kanagawa (JP); Koji OGURA, Tachikawa Tokyo (JP)

(73) Assignee: KABUSHIKI KAISHA TOSHIBA, Tokyo (JP)

(21) Appl. No.: 14/550,564

(22) Filed: Nov. 21, 2014

(30) Foreign Application Priority Data
Jan. 28, 2014 (JP) 2014-013366

(51) Int. Cl. H04L 5/00; H04W 24/08; H04W 72/02

(52) U.S. Cl. CPC H04L 5/0062; H04W 72/02; H04W 24/08

(57) ABSTRACT

According to one embodiment, a wireless communication apparatus has a transmitter, a receiver, and a transmission timing instructor. The transmitter transmits a signal by using a first wireless communication scheme. The receiver receives a signal transmitted by using the first wireless communication scheme. The receiver detects a signal of which a frequency band includes at least a part of a frequency band used in the first wireless communication scheme, which is other than a signal transmitted by using the first wireless communication scheme. The transmission timing instructor instructs the transmitter to transmit a signal by using the first wireless communication scheme if the receiver does not receive a signal over a predetermined time from a detection of a signal other than a signal transmitted by using the first wireless communication scheme.

### CROSS-REFERENCE TO RELATED APPLICATIONS

This application is based upon and claims the benefit of priority from Japanese Patent Application No. 2014-013366, filed Jan. 28, 2014; the entire contents of which are incorporated herein by reference.

### FIELD

Embodiments described herein relate generally to a wireless communication apparatus and a wireless communication method.

### BACKGROUND

There may be overlapping of frequency bands between a plurality of wireless communication schemes, such as close-proximity wireless communication in which the distance communicated is approximately several centimeters and near-field wireless communication in which the distance communicated is several meters or greater. In this case, when communicating by one of the wireless communication schemes, a signal of another wireless communication scheme can cause interference, which can lower the communication efficiency.

### BRIEF DESCRIPTION OF THE DRAWINGS

FIG. 1 is a general block diagram showing a wireless environment of a wireless communication system according to a first embodiment.

FIG. 2 is a block diagram showing an example of the general constitution of the wireless communication apparatus 1.

FIG. 3 is a flowchart showing an example of the operation of the wireless communication apparatus 1.

FIG. 4 is a flowchart showing an example of the operation of the wireless communication apparatus 1.

FIG. 5 is a flowchart showing an example of the operation of the wireless communication apparatus 1.

FIG. 6 is a timing chart of the processing for the wireless communication apparatus 1 transmitting a Data frame when the positional relationship is Case B.

FIG. 7 is a block diagram showing an example of the general constitution of the wireless communication apparatus 1 in a second embodiment.

FIG. 8 is a flowchart showing an example of the operation of the wireless communication apparatus 1 in the second embodiment.

FIG. 9 is a timing chart of the processing for the wireless communication apparatus 1 transmitting a Data frame when the positional relationship is Case B.

FIG. 10 is a block diagram showing an example of the general constitution of the wireless communication apparatus 1 in a third embodiment.

FIG. 11 is a flowchart showing an example of the processing performed by the transmission success rate measurer 25 and the frame length controller 18b.

FIG. 12 is a block diagram showing an example of the general constitution of the wireless communication apparatus 1 in a fourth embodiment.

FIG. 13 is a flowchart showing an example of the processing by the frame length controller 18c and the throughput measurer 26.

FIG. 14 is a graph showing an example of the relationship between the frame time length and the effective throughput.

FIG. 15 is a block diagram showing an example of the general constitution of the wireless communication apparatus 1 in a fifth embodiment.

FIG. 16 is a flowchart showing an example of the operation of the wireless communication apparatus 1 in the fifth embodiment.

FIG. 17 is a flowchart showing an example of the operation of the wireless communication apparatus 1 in the fifth embodiment.

### DETAILED DESCRIPTION

According to some embodiments, a wireless communication apparatus has a transmitter, a receiver, and a transmission timing instructor. The transmitter transmits a signal by using a first wireless communication scheme. The receiver receives a signal transmitted by using the first wireless communication scheme. The receiver detects a signal of which a frequency band includes at least a part of a frequency band used in the first wireless communication scheme, which is other than a signal transmitted by using the first wireless communication scheme. The transmission timing instructor instructs the transmitter to transmit a signal by using the first wireless communication scheme if the receiver does not receive a signal over a predetermined time from a detection of a signal other than a signal transmitted by using the first wireless communication scheme.

Embodiments of a wireless communication apparatus and a wireless communication method will be described below, with references made to the drawings.

### First Embodiment

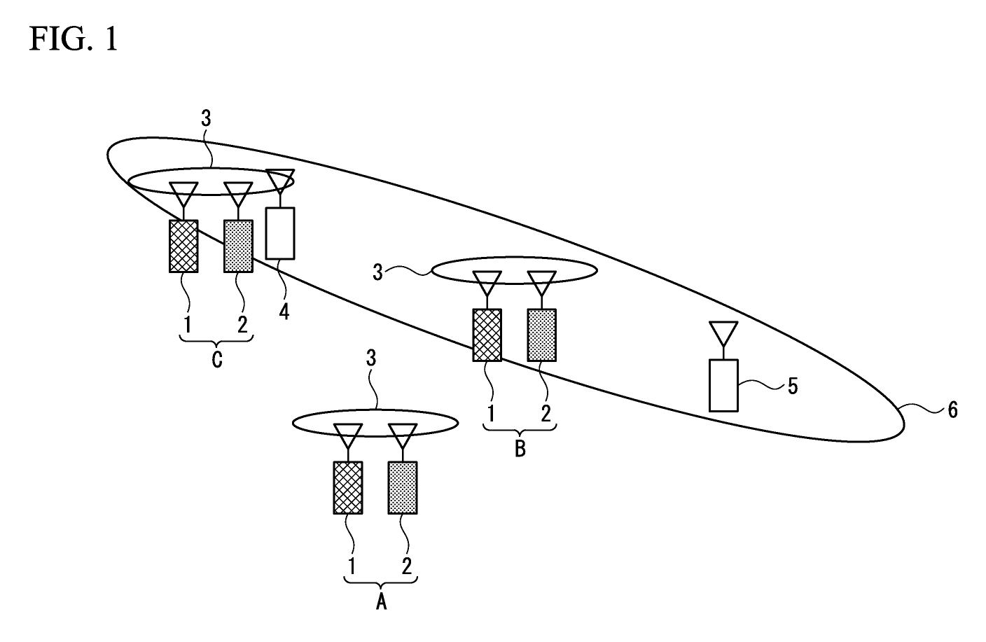

FIG. 1 is a general block diagram showing the wireless environment of a wireless communication system according to the first embodiment. The wireless communication system according to the present embodiment includes a wireless communication apparatus 1 and a wireless communication apparatus 2. The wireless communication apparatus 1 and the wireless communication apparatus 2 communicate in the communication area 3 (range over which a radio signal reaches), using a first wireless communication scheme called mmFlash (registered trademark). The mmFlash communication scheme is close-proximity millimeter wave wireless communication. In FIG. 1, wireless communication apparatus 4 and wireless communication apparatus 5 are communicating wirelessly over the communication area (range over which a radio signal reaches) 6, using a second wireless communication scheme called wireless LAN (Local Area Network) (IEEE 802.11ad). Wireless LAN is near-field wireless communication. The frequency bands of mmFlash and of the wireless LAN used by the wireless communication apparatuses 4 and 5 overlap.

In this case, there are the three positional relationships A, B, and C as shown in FIG. 1 regarding interference between the wireless communication system by the wireless communication apparatuses 1 and 2 and the wireless communication system by the wireless communication apparatuses 4 and 5. In the positional relationship A (Case A), because there is no mutual overlapping between the communication areas, each of the systems can communicate wirelessly without being receiving interference from the other system. In the positional relationship B (Case B), the wireless communication system by the wireless communication apparatuses 1 and 2 is positioned within the communication area 6 (range over which a radio signal reaches) of the wireless communication system by the wireless communication apparatuses 4 and 5. However, the wireless communication system by the wireless communication apparatuses 4 and 5 is not within the communication area 3 of the wireless communication system by the wireless communication apparatuses 1 and 2. For this reason, although the wireless communication system by the wireless communication apparatuses 1 and 2 receives interference from the wireless communication system by the wireless communication apparatuses 4 and 5, the wireless communication system by the wireless communication apparatuses 4 and 5 does not receive interference from the wireless communication system by the wireless communication apparatuses 1 and 2. In the positional relationship C (Case C), because the systems are mutually positioned within the communication area (range over which a radio signal reaches) of the other system, both systems give and receive interference.

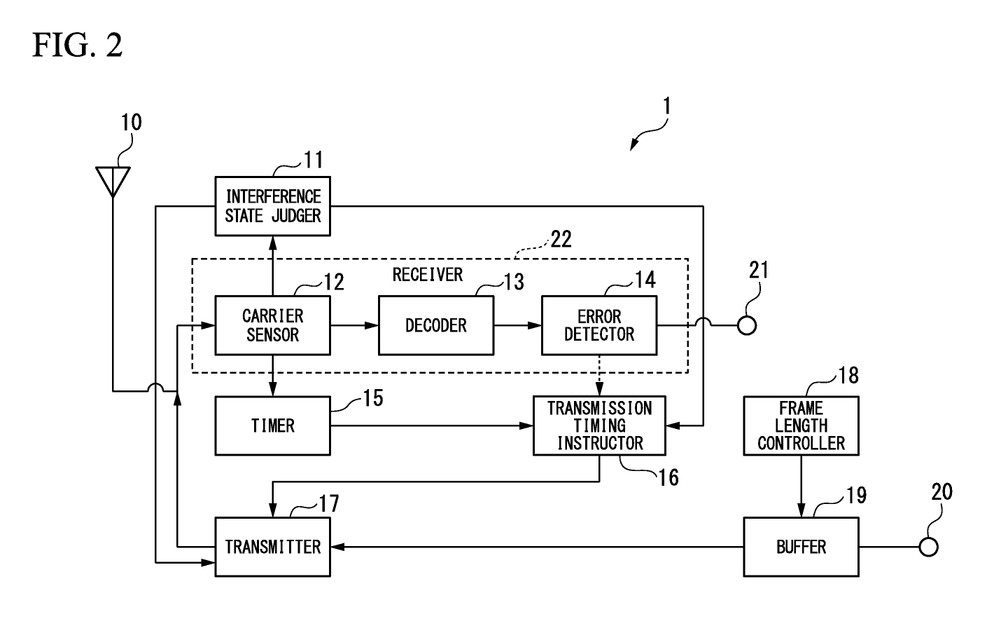

FIG. 2 is a block diagram showing an example of the general constitution of the wireless communication apparatus 1. Because the constitution of the wireless communication apparatus 2 is the same as that of the wireless communication apparatus 1, the description thereof will be omitted. However, in the wireless communication apparatus 2, the value of time TO, which will be described later, differs from that of the wireless communication apparatus 1. This enables avoidance of simultaneously starting the transmission of data by the wireless communication apparatuses 1 and 2.

The wireless communication apparatus 1 includes an antenna 10, an interference state judger 11, a receiver 22, a timer 15, a transmission timing instructor 16, a transmitter 17, a frame length controller 18, a buffer 19, an input terminal 20, and an output terminal 21. The receiver 22 includes a carrier sensor 12, a decoder 13, and an error detector 14.

The antenna 10 transmits a signal to the wireless communication apparatus 2 and receives a signal from the wireless communication apparatus 2. The interference state judger 11 judges whether the positional relationship with another wireless communication system such as the wireless communication system by the wireless communication apparatuses 4 and 5 is Case A, Case B, or Case C. An example of the method of judgment is as follows. First, when the carrier sensor 12 detects the carrier, which will be described later, the interference state judger 11 judges that it is either Case B or C. When the carrier sensor 12 does not detect the carrier, the interference state judger 11 judges that it is Case A. If the judgment is that it is either Case B or Case C, the interference state judger 11 causes the transmitter 17 to transmit a signal. After the signal transmission is completed, if the carrier sensor 12 detects a carrier during the DIFS, (Distributed (coordination function) Interframe Space), the interference state judger 11 judges Case B. If the carrier sensor 12 does not detect a carrier during the DIFS, the interference state judger 11 judges Case C. The DIFS is the time interval in wireless LAN from the time at which signal power from a channel in the busy state no longer is detected until it is judged that a change has occurred to the idle state.

The carrier sensor 12 detects the carrier in the frequency band used by mmFlash from the signal received by the antenna 10. The decoder 13 decodes the signal of the carrier detected by the carrier sensor 12 and obtains a bit stream represented by the signal. The error detector 14 performs error detection, treating the bit stream obtained by the decoder 13 as a frame in mmFlash. A CRC (cyclic redundancy check) is used in the error detection. When it detects an error, the error detector 14 judges that the checked signal is a signal other than an mmFlash signal. If the error detector 14 does not detect an error, the error detector 14 judges that the checked signal is an mmFlash signal.

The timer 15 measures the time from the point at which the carrier sensor 12 stops detecting the carrier. When a predetermined time T0 has elapsed without the carrier sensor 12 detecting the carrier, the timer 15 gives notification to the transmission timing instructor 16. The time T0 is 4 micro-seconds in the present embodiment, but it is sufficient that it is equal to or more than the SIFS (Short Interframe Space). The SIFS is the time interval from the completion of the transmission of a data frame until the transmission of an ACK (acknowledgment) frame in wireless LAN, and in IEEE 802.11ad, this is 3 micro-seconds. The time T0 is desirably a value smaller than DIFS. The ACK frame is a response transmitted by an apparatus that has received a data frame, and is a response verifying the delivery of the data frame.

When the interference state judger 11 judges either Case B or Case C, the transmission timing instructor 16 instructs the transmitter 17 regarding the timing of the transmission of data. The timing of the transmission of data is when, from the detection of a signal other than an mmFlash signal, the carrier sensor 12 does not detect a signal over the predetermined time T0. Specifically, when the timer 15 gives notification that the predetermined time T0 has elapsed, the transmission timing instructor 16 acquires the last error detection result by the error detector 14. If the acquired error detection result indicates that an error has been detected, the transmission timing instructor 16 instructs the transmitter 17 to transmit. That is, when the elapse of the predetermined time T0 is notified from the timer 15, if the acquired error detection result indicates that an error had been detected, the transmission timing instructor 16 judges that there is no signal detected after detection of the signal other than an mm Flash signal over the predetermined time T0.

When instructed by the transmission timing instructor 16 to transmit, the transmitter 17 acquires a frame from the buffer 19. The transmitter 17 generates a signal representing the acquired frame by modulating the acquired frame. The transmitter 17 transmits the generated signal to the wireless communication apparatus 2, via the antenna 10. The frame length controller 18 sets the previously stored frame time length D into the buffer 19. This frame time length D is a value in accordance with the maximum value of the backoff time in wireless LAN. More specifically, the frame time length D is, when the transmitter 17 is instructed by the transmission timing instructor 16 to transmit a frame, the frame time length for which the response to the frame (ACK frame) is before the maximum value of the backoff time in wireless LAN. Specific examples of the frame time length D will be described later.

The buffer 19 generates a frame having the frame time length D from the data input from the input terminal 20 and stores this in a queue. If there is a request from the transmitter 17, the buffer 19 reads out the frame from the queue and inputs it to the transmitter 17. The input terminal 20 receives the input of the data to be transmitted. The output terminal 21 outputs the data of a frame in which the error detector 14 does not detect an error.

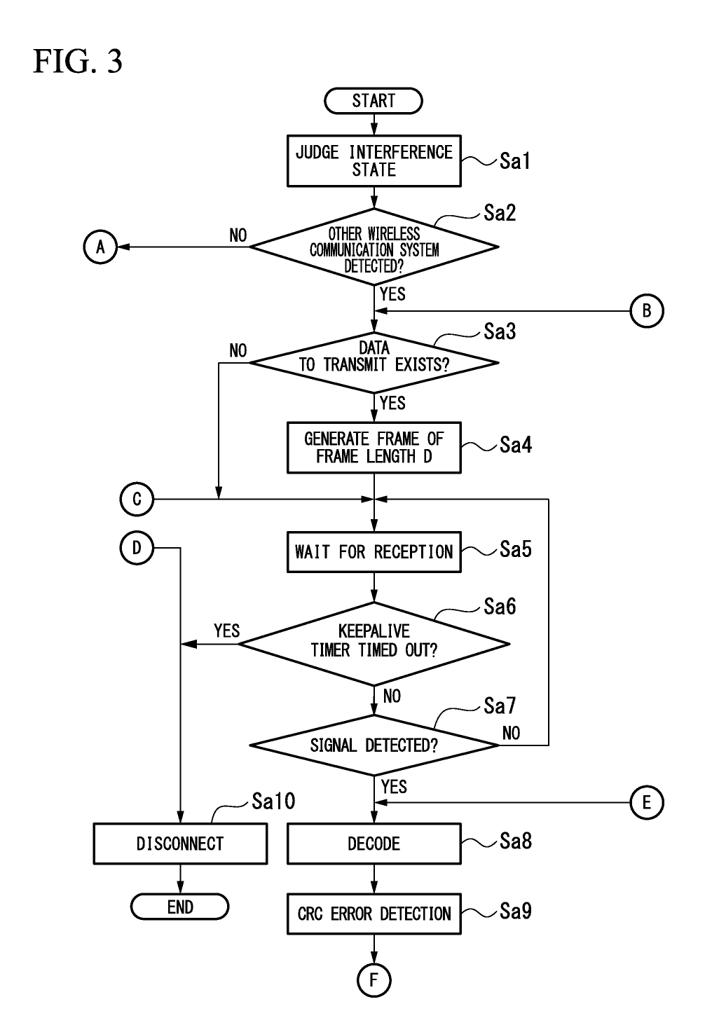

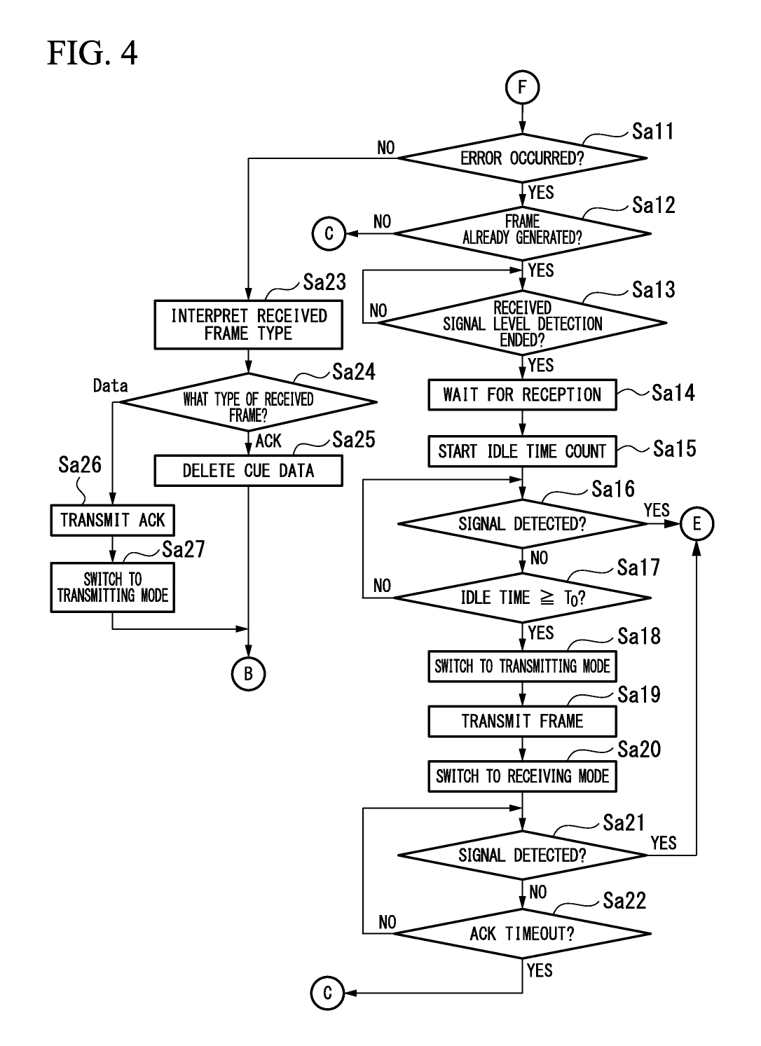

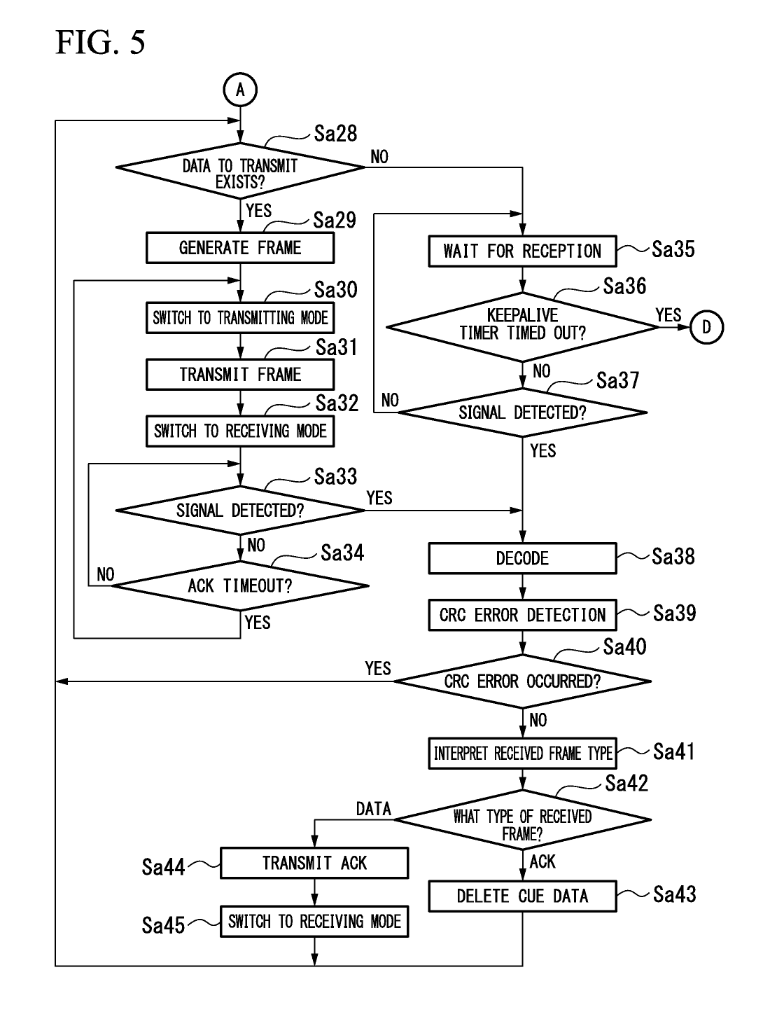

FIG. 3 to FIG. 5 are flowcharts showing an example of the operation of the wireless communication apparatus 1. The flowchart shown in FIG. 3 shows the processing that includes from the establishment of a connection with the wireless communication apparatus 2 to the frame transmission. First, the interference state judger 11 judges whether the positional relationship with another wireless communication system is Case A, Case B, or Case C (step Sa1). In step Sa1, if the judgment is Case 13 or Case C, that is, if another wireless communication system is detected (Yes in step Sa2), the buffer 19 judges whether or not data to be transmitted is stored (step Sa3).

If the judgment is that data to be transmitted is not stored (No in step Sa3), processing proceeds to step Sa5. However, if the judgment is that data to be transmitted is stored (Yes in step Sa3), the buffer 19 generates a frame of the frame time length D set by the frame length controller 18, and stores the generated frame in a queue (step Sa4), after which processing proceeds to step Sa5. As described above, the frame time length D is the frame time length for which the completion of the transmission of the frame is before the maximum value of the backoff time in wireless LAN. Specific examples of the frame time length D will be described later. The maximum value of the backoff time is the sum of the maximum values of the DIFS and the initial contention window.

In step Sa5, the carrier sensor 12 waits for reception. During the wait for reception, the carrier sensor 12 judges whether or not a KeepAlive timer has timed out (step Sa6) and, if there is a timeout (Yes in step Sa6) disconnects (step Sa10) and ends the processing.

However, if a timeout does not occur in step Sa6, the carrier sensor 12 judges whether or not a signal (carrier) is detected (step Sa7). If the signal is not detected (No in step Sa7), processing returns to step Sa5, and the carrier sensor 12 continues to wait for reception. However, in step Sa7, if a signal is detected (Yes in step Sa7), the decoder 13 decodes the detected signal (step Sa8). After completion of the decoding, the error detector 14 performs CRC error detection on the decoding results from the decoder 13 (step Sa9). Next, the error detector 14 judges by the CRC error detection in step Sa9 whether or not an error is detected (step Sa11).

In step Sa11, if the judgment is that an error had been detected (Yes in step Sa11), the buffer 19 judges whether or not a frame has already been generated (step Sa12). If data to be transmitted has not been input to the buffer 19 and a frame has not been generated (No in step Sa12), processing returns to step Sa5, and the carrier sensor 12 continues to wait for reception. However, in step Sa12, if the judgment is that a frame has already been generated (Yes in step Sa12), the carrier sensor 12 judges whether or not the receiving level detection of the signal in which an error is detected in step Sa11 has ended (step Sa13). In this case, the end of the receiving level detection is the receiving level of the signal received by the antenna 10 being low and the carrier sensor 12 not being able to detect the carrier.

A wait is made for the receiving level detection to end, and when the receiving level detection ends (step Sa13), the carrier sensor 12 starts waiting for reception (step Sa14), and the timer 15 starts counting the Idle time period (step Sa15). Next, the carrier sensor 12, while waiting for reception, judges whether or not a signal (carrier) has been detected (step Sa16). In step Sa16, when the judgment is made that the signal is detected, that is, when carrier Busy is detected (Yes in step Sa16), processing returns to step Sa8, and the decoder 13 starts decoding.

However, if the judgment in step Sa16 is that a signal is not detected, that is, that carrier Idle is detected (No in step Sa16), the timer 15 judges whether or not the counted Idle time period is the time T0 or greater (step Sa17). In step Sa17, if the judgment is that the Idle time period is not the time TO or greater (No in step Sa17), processing returns to step Sa16. However, if the judgment in step Sa17 is that the Idle time period is the time T0 or greater (Yes in step Sa17), the timer 15 notifies the transmission timing instructor 16 that the Idle time period has reached or exceeded the time T0. Because the error detector 14 judges in step Sa11 that there is an error, the transmission timing instructor 16 instructs the carrier sensor 12 and the transmitter 17 to switch to the transmitting mode (step Sa18).

When the switching to the transmitting mode is completed, the transmitter 17 acquires a frame from the buffer 19 and transmits the frame (step Sa19). When the frame transmission is completed, the transmitter 17 switches to the receiving mode and instructs the carrier sensor 12 to switch to the receiving mode (step Sa20). When switching to the receiving mode is completed, the carrier sensor 12 starts waiting for reception and judges whether or not a signal is detected (step Sa21). If the judgment is that a signal has been detected (Yes in step Sa21), processing returns to step Sa8, and the decoder 13 decodes the detected signal.

However, if the judgment in step Sa21 is that a signal has not been detected (No in step Sa21), a judgment is made as to whether or not the ACK timer has timed out (step Sa22). If the judgment is that timeout has not occurred (No in step Sa22), processing returns to step Sa21. The ACK timer times out by the time from the completion of transmission of the frame by the transmitter 17 until the transmission of ACK by the wireless communication apparatus 2 for the received frame. However, if the judgment in step Sa22 is that timeout occurred, processing returns to step Sa5.

However, if in step Sa11 the judgment is that there has been no error (No in step Sa11), the error detector 14 interprets the type of frame (received frame) that is the subject of the error detection (step Sa23). As a result of the interpretation, if the type of the received frame is an ACK frame (ACK in step Sa24), the buffer 19 deletes from the queue the last frame transmitted (step Sa25), after which processing returns to step Sa3. However, if the result of the interpretation in step Sa23 is that the type of the received frame is a Data frame (Data in step Sa24), the transmitter 17 transmits an ACK frame (step Sa26). When the transmission of the ACK frame is completed, the transmitter 17 and the carrier sensor 12 switch to the receiving mode (step Sa27), after which processing returns to step Sa3.

However, if in step Sa1 the judgment is Case A, that is, that another wireless communication system is not detected (No at Sa2), the buffer 19 judges whether or not data to be transmitted is stored (step Sa28). If the judgment is that data to be transmitted is not stored (No in step S28), the carrier sensor 12 waits for reception (step Sa35). During the wait for reception, the carrier sensor 12 judges whether or not a KeepAlive timer has timed out (step Sa36). If there is a timeout (Yes in step Sa36), disconnects (step Sa10), whereupon processing ends.

However, if a timeout does not occur in step S36, the carrier sensor 12 judges whether or not a signal (carrier) is detected (step Sa37). If the signal is not detected (No in step Sa37), processing returns to step Sa35, and the carrier sensor 12 continues to wait for reception. However, if a signal is detected in step Sa37 (Yes in step Sa37), the decoder 13 decodes the detected signal (step Sa38). After completion of the decoding, the error detector 14 performs CRC error detection on the decoding results from the decoder 13 (step Sa39). Next, the error detector 14 judges by the CRC error detection in step Sa39 whether or not an error is detected (step Sa40). In step Sa40, if the judgment is that an error had occurred (Yes in step Sa40), processing returns to step

Sa28.

However, if the judgment in step Sa40 is that there is no error detected (No in step Sa40), the error detector 14 interprets the type of the frame (received frame) that is the subject of the error detection (step Sa41). As a result of the interpretation, if the type of the received frame is an ACK frame (ACK in step Sa42), the buffer 19 deletes from the queue the last frame that is transmitted (step Sa43), after which processing returns to step Sa28. However, if the result of the interpretation in step Sa41 is that the type of the received frame is a Data frame (Data in step Sa42), the transmitter 17 transmits an ACK frame (step Sa44). When the transmission of the ACK frame is completed, the transmitter 17 and the carrier sensor 12 switch to the receiving mode (step Sa45), after which processing returns to step Sa28.

However, if in step Sa28 the judgment is that data to be transmitted is stored (Yes in step Sa28), the buffer 19 generates a frame of a frame time length set by the frame length controller 18, and stores the generated frame in a queue (step Sa29). The frame length controller 18 may determine the frame time length in any manner. For example, the frame length controller 18 may take the maximum value as the frame time length if the data stored in the buffer 19 exceeds the maximum value of the frame time length. Also, the frame length controller 18 may make the frame time length a length in accordance with the stored data if the data stored in the buffer 19 does not exceed the maximum value of the frame time length.

Next, the carrier sensor 12 and the transmitter 17 switch to the transmitting mode (step Sa30). When the switching to the transmitting mode is completed, the transmitter 17 acquires a frame from the buffer 19 and transmits the frame (step Sa31). When the frame transmission is completed, the transmitter 17 switches to the receiving mode and instructs the carrier sensor 12 to switch to the receiving mode (step Sa32). When the switching to the receiving mode is completed, the carrier sensor 12 starts waiting for reception and judges whether or not a signal is detected (step Sa33). If the judgment is that a signal has been detected (Yes in step Sa33), processing returns to step Sa38, and the decoder 13 decodes the detected signal.

However, if the judgment in step Sa33 is that a signal has not been detected (No in step Sa33), a judgment is made as to whether or not the ACK timer has timed out (step Sa34). If the judgment is that timeout has not occurred (No in step Sa34), processing returns to step Sa33. However, if the judgment in step Sa34 is that timeout has occurred, processing returns to step Sa30 so as to perform retransmission.

After performing CRC error detection in step Sa9, a wait is made in step Sa13 for the detection of the received signal level to end, and the detection of the received signal level by the carrier sensor 12 and the CRC check by the error detector 14 may be performed in parallel.

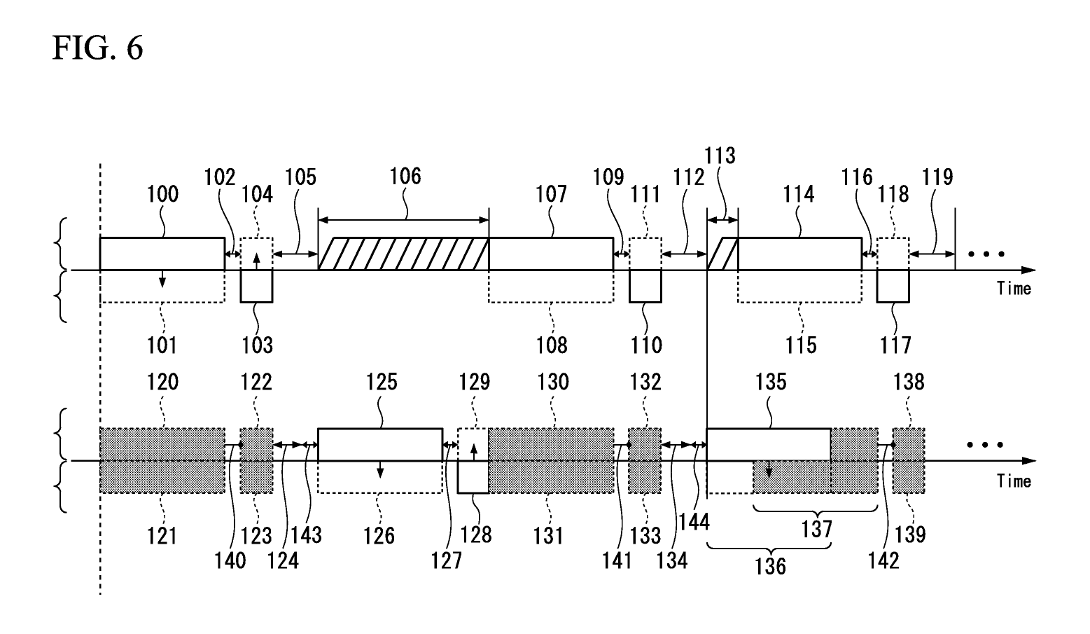

FIG. 6 is a timing chart of the processing for the wireless communication apparatus 1 transmitting a Data frame when the positional relationship is Case B. The upper part of FIG. 6 shows the operation P4 of the wireless communication apparatus 4 and the operation P5 of the wireless communication apparatus 5. The lower part of FIG. 6 shows the operation P1 of the wireless communication apparatus 1 and the operation P2 of the wireless communication apparatus 2. When the wireless communication apparatus 4 transmits the Data 1-1 frame (100) the wireless communication apparatus 5 receives (101). However, because there is no signal format compatibility between mmFlash and wireless LAN, the Data 1-1 frame results in a CRC error at the wireless communication apparatus 1 and the wireless communication apparatus 2 (120 and 121, respectively).

The wireless communication apparatus 1 performs carrier sensing from the timing of the ending of the detection of the Data 1-1 frame which had a CRC error (140), but Busy is detected (122) before carrier Idle is continuously detected for the predetermined time period T0. This is because the wireless communication apparatus 5 transmits an ACK frame for the received Data 1-1 frame (103) after the elapse of SISF in wireless LAN (102). For example, in IEEE 802.11ad, the SIFS time is determined as 3 micro-seconds. In this manner, the time T0 is larger than SIFS in wireless LAN. For this reason, the wireless communication apparatus 1 can avoid transmission of a data frame at the timing of the transmission of the ACK frame in wireless LAN.

The wireless communication apparatus 4 receives this ACK frame (104). The ACK frame transmitted by the wireless communication apparatus 5 results in a CRC error at the wireless communication apparatus 1 and the wireless communication apparatus 2 (122 and 123, respectively). The wireless communication apparatus 1 performs carrier sensing from the timing of the completion of detection of the ACK frame which had a CRC error (124). Because the carrier Idle is continuously detected for the predetermined time period T0 (124), the wireless communication apparatus 1 switches to the transmitting mode (143) and transmits the Data 2-1 frame (125).

Upon receiving the Data 2-1 frame (126), the wireless communication apparatus 2 transmits the ACK frame (128) after the elapse of the mmFlash SIFS time 127. In mmFlash, the SIFS time period is determined as 2 micro-seconds. The wireless communication apparatus 1 receives this ACK frame (129). Upon receiving the ACK frame (104), the wireless communication apparatus 4 waits for transmission by the random backoff 106 after the elapse of the DIFS time 105.

This random backoff performs waiting for transmission as long as carrier Idle is detected for a time that is a randomly selected integer within a range of a predetermined contention window, multiplied by a slot time. For example, in IEEE 802.11ad, the DIFS time is determined as 13 micro-seconds, the contention window initial value is determined as 15, and one slot time is determined as 5 micro-seconds.

The Data 2-1 frame transmitted (125) by the wireless communication apparatus 1 does not reach the wireless communication apparatus 4 and the wireless communication apparatus 5. For this reason, during the backoff time 106, in the carrier sensing by the wireless communication apparatus 4, carrier Idle is detected. Because the Data 2-1 frame transmitted (125) by the wireless communication apparatus 1 and the ACK frame transmitted (128) by the wireless communication apparatus 2 end within the backoff time of the wireless communication apparatus 4, these transmissions succeed. For example, if the integer randomly selected by the wireless communication apparatus 4 is 12, the result of summing the DIFS time period 105 of the wireless communication apparatus 4 and the backoff time 106 is the calculation 13 micro-seconds+5 micro-seconds * 12=73 micro-seconds.

With respect to this, if the time T0 (124) is made 4 micro-seconds, the time for switching to the transmitting mode (143) is made 3 micro-seconds, the Data 2-1 frame time length is made 50 micro-seconds, the SIFS time period 127 is made 2 micro-seconds, and the ACK frame 128 time length is made 4 micro-seconds, the total is 4 micro-seconds+3 micro-seconds+50 micro-seconds+2 micro-seconds+4 micro-seconds=63 micro-seconds. For this reason, because the Data 2-1 frame transmitted (125) by the wireless communication apparatus 1 and the ACK frame transmitted (128) by the wireless communication apparatus 2 end within the backoff time 106 of the wireless communication apparatus 4, these transmissions succeed.

As described above, the frame length controller 18 sets the frame time length D set into the buffer 19 so that the completion of the transmission of the ACK frame with respect to the frame is within the maximum value of the backoff time. In IEEE 802.11ad, the maximum value of the backoff time is DIFS 13 micro-seconds+slot time 5 micro-seconds * maximum number of slots 15=88 micro-seconds. In contrast, the transmission of a frame requires the time T0 4 micro-seconds+the time to switch to the transmitting mode 3 micro-seconds=7 micro-seconds. After the frame transmission has been completed, the time until completion of the transmission of the ACK frame is the SIFS of mmFlash 2 micro-seconds+ACK frame length 4 micro-seconds=6 micro-seconds. The frame time length D, therefore, is 75 micro-seconds, which is the above-noted 7 micro-seconds and 6 micro-seconds subtracted from the maximum value 88 micro-seconds of the backoff time.

The time T0 is a value smaller than DIFS in wireless LAN. The result is that, after transmission of the ACK frame by wireless LAN, when the wireless communication apparatus 1 transmits, it can transmit before the wireless communication apparatus 4. When the positional relationship is Case C, the wireless communication apparatus 1 has the wireless communication apparatus 4 detect the data frame that it has transmitted and does not allow it to transmit until the data frame transmission has been completed.

After the backoff time 106 has ended, the wireless communication apparatus 4 transmits the Data 1-2 frame (107), and the wireless communication apparatus 5 receives (108). However, because the signal formats between the wireless communication apparatuses 1 and 2 and the wireless communication apparatuses 4 and 5 are not compatible, at the wireless communication apparatuses 1 and 2, the Data 1-2 frame results in CRC errors (130 and 131, respectively). Wireless communication apparatus performs carrier sensing from the timing of the end of detection of the Data 1-2 frame which had the CRC error (141), and detects Busy before carrier Idle is continuously detected for the predetermined time T0.

This is because the wireless communication apparatus 5 transmits an ACK frame (110) for the received (108) Data 1-2 frame after the elapse of the SISF time 109 in wireless LAN. The wireless communication apparatus 4 receives (111) the ACK frame. The ACK frame transmitted (110) by the wireless communication apparatus 5 results in CRC errors (132 and 133, respectively) at the wireless communication apparatus 1 and the wireless communication apparatus 2. The wireless communication apparatus 1 performs carrier sensing (134) from the timing of the end of the detection of the ACK frame that had the CRC errors.

When this occurs, because the wireless communication apparatus 1 detects carrier Idle continuously for the predetermined time T0 (134), it switches to the transmitting mode (144) and transmits the Data 2-2 frame 135. After the elapse of the DIFS time 112, the wireless communication apparatus 4 that received (111) the ACK frame waits for transmission by the random backoff 113. Because the Data 2-2 frame transmitted (135) by the wireless communication apparatus 1 does not reach the wireless communication apparatus 4 and the wireless communication apparatus 5, Idle is detected by carrier sensing during the backoff performed by the wireless communication apparatus 4.

With respect to this random backoff 113 as well, the wireless communication apparatus 4 randomly selects an integer within a predetermined contention window range, and waits for transmission as long as Idle is detected by carrier sensing for a time that is the selected integer value multiplied by the slot time. In FIG. 6, the selected integer value is smaller than the integer value selected with respect to the random backoff 106. For example, if the wireless communication apparatus 4 randomly selects the integer 3, the result of summing the DIFS time 112 of the wireless communication apparatus 4 and the backoff time 113 is the calculation 13 micro-seconds+5 micro-seconds * 3=28 micro-seconds.

With respect to this, if the time T0 (134) is made 4 micro-seconds, the time for switching to the transmitting mode (144) is made 3 micro-seconds, and the Data 2-2 frame time length is made 50 micro-seconds, the total is 4 micro-seconds+3 micro-seconds+50 micro-seconds=57 micro-seconds. For this reason, during the reception (136) by the wireless communication apparatus 2 of the Data 2-1 frame transmitted (135) by the wireless communication apparatus 1, the Data 1-3 frame transmitted (114) by the wireless communication apparatus 4 becomes interference 137. As a result, the reception (136) of the Data 2-2 frame by the wireless communication apparatus 2 fails. In this manner, if the transmission of the Data frame by the wireless communication apparatus 1 and the transmission of the ACK frame by the wireless communication apparatus 2 are completed during the backoff time determined by an integer for the backoff time randomly selected by the wireless communication apparatus 4, the transmission of the Data frame by the wireless communication apparatus 1 succeeds.

In this manner, if a signal is not detected by the receiver 22 over the predetermined time TO from the detection of a signal other than an mmFlash (first wireless communication scheme) signal, the transmission timing instructor 16 instructs the transmitter 17 to transmit. This enables the suppression of transmission by the transmitter 17 at a transmission timing in accordance with a response such as an ACK frame in communication by another wireless communication scheme such as wireless LAN. It is therefore possible to suppress the reception of interference by a response in another wireless communication scheme, which would reduce the communication efficiency.

The predetermined time T0 in wireless LAN is equal to or greater than the time SIFS from the reception of a signal until the transmission of a response. This enables suppression of the possibility of transmission by the transmitter 17 at the timing of transmission of an ACK frame in communication by wireless LAN.

When there is a transmission request in wireless LAN, the frame length controller 18 determines the frame time length in accordance with the maximum value of the backoff time from the detection of a response until the next transmission as the frame length of a frame represented by a signal to be transmitted by the transmitter 17. This enables suppression of the probability that, during transmission of a frame by the transmitter 17, a wireless LAN frame will be sent.

The frame length controller 18 determines the frame time length so that, after the transmitter 17 transmits a frame, a time when transmission of the ACK frame with respect to the frame is completed by another wireless communication apparatus is before a time corresponding to the maximum value of the backoff time. This enables suppression of the probability of a wireless LAN frame transmission during frame transmission by the transmitter 17 and during ACK frame transmission with respect to that frame by the other wireless communication apparatus.

The predetermined time T0 of the wireless communication apparatus 1 is different from the value in the other wireless communication apparatus (wireless communication apparatus 2) in wireless communication using mmFlash. This enables the suppression of transmitting simultaneously with the other wireless communication apparatus, when a wireless LAN Idle is detected.

### Second Embodiment

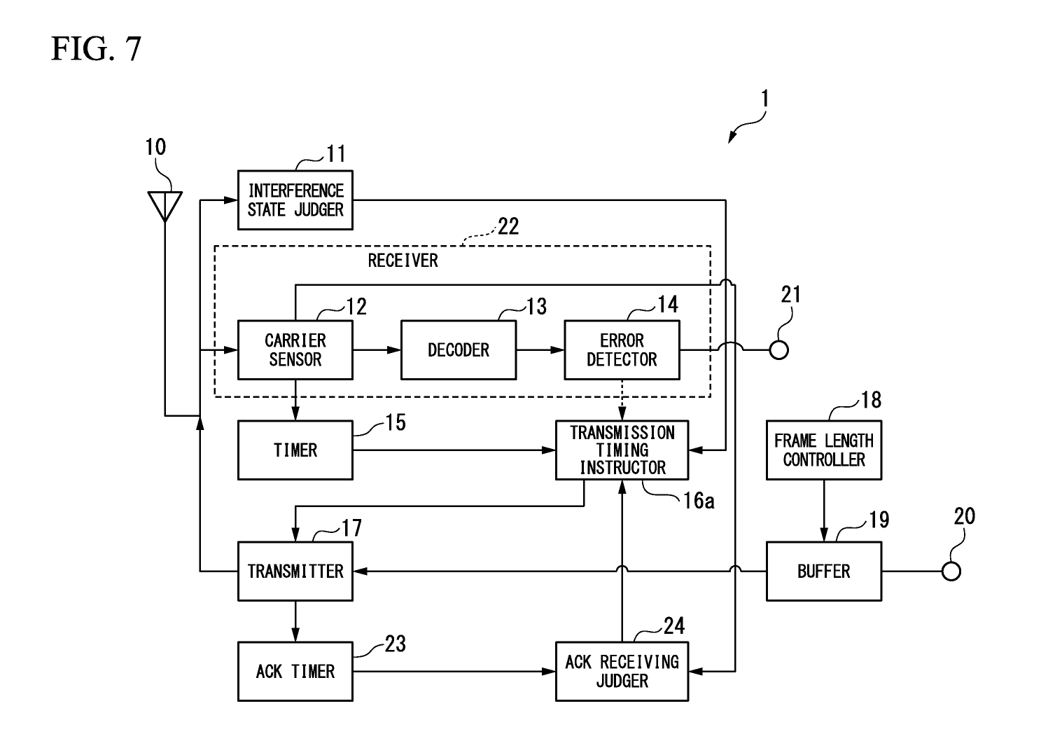

The wireless communication apparatuses 1 and 2 in the second embodiment have substantially the same constitution as the wireless communication apparatuses 1 and 2 in the first embodiment, but are partially different. In the following, the part that is different from the first embodiment will be described. FIG. 7 is a block diagram showing an example of the general constitution of the wireless communication apparatus 1 in the present embodiment. In this drawing, parts that correspond to those in FIG. 2 are assigned the same reference numerals (10 to 15 and 17 to 22), and the descriptions thereof will be omitted. The wireless communication apparatus 1 in the present embodiment differs from the wireless communication apparatus 1 in the first embodiment with regard to having an ACK timer 23 and an ACK receiving judger 24 and with regard to having a transmission timing instructor 16a in place of the transmission timing instructor 16.

The ACK timer 23 counts the time from transmission of a data frame by the transmitter 17 until the time for receiving the ACK frame times out. When the carrier sensor 12 detects a carrier, the ACK receiving judger 24 judges whether or not the timing of that detection is within the ACK frame reception time. Similar to the transmission timing instructor 16 shown in FIG. 2, the transmission timing instructor 16a determines the transmission timing. However, of the signals for which the error detector 14 detects a CRC error, the transmission timing instructor 16a treats signals judged by the ACK receiving judger 24 to be within the reception time for the ACK frame as mmFlash signals. That is, for a signal judged by the ACK receiving judger 24 to be within the ACK frame reception time, the transmission timing instructor 16a does not instruct the transmitter 17 to transmit during the predetermined time TO after receiving that signal, even in the Idle state.

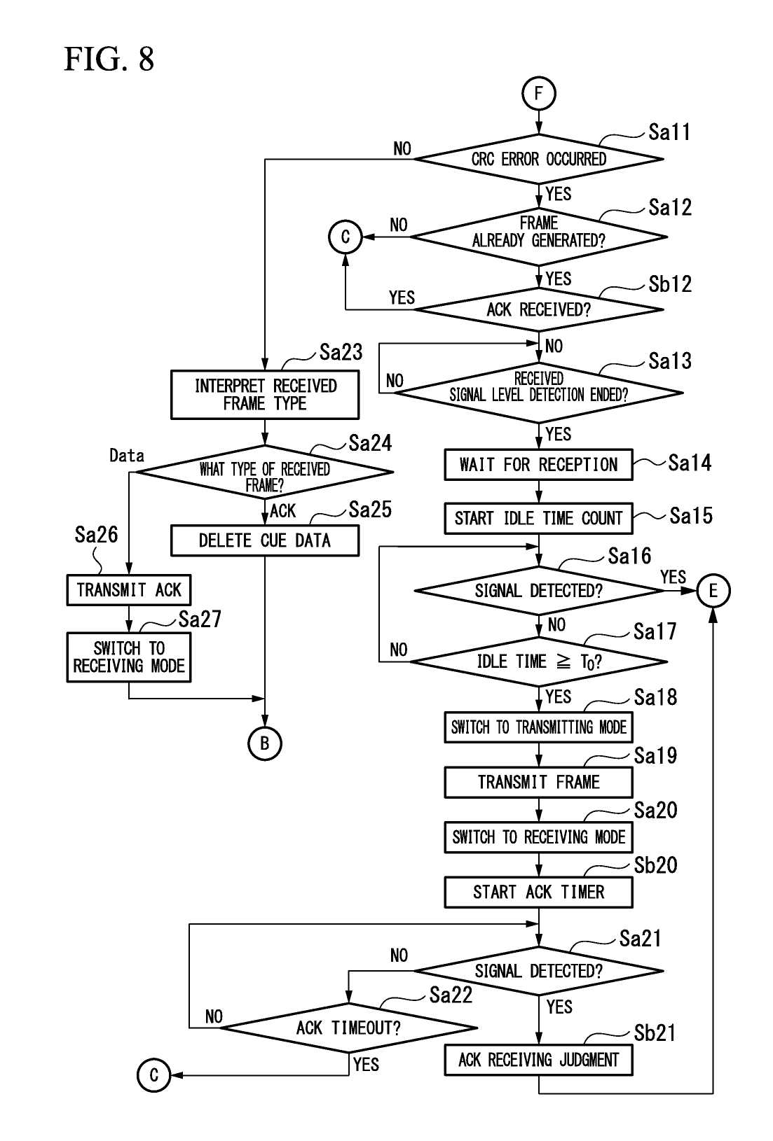

FIG. 8 is a flowchart showing an example of the operation of the wireless communication apparatus 1 in the present embodiment. The flowchart in the present embodiment differs from the flowcharts of FIG. 3 to FIG. 5 only with regard to the inclusion of steps Sb12, Sb20, and Sb21. FIG. 8 shows only the parts of the flowchart for the present embodiment that include parts that are different. Step Sb12 is performed before step Sa13 when, in step Sa12 the judgment is made that the frame has already been generated (Yes in step Sa12). Step Sb20 is performed between step Sa20 and step Sa21. Step Sb21 is performed before step Sa8 when, in step Sa21, the judgment is made that a signal has been detected (Yes in step Sa21).

In step Sb12, the transmission timing instructor 16a judges whether or not, when the last signal is detected, this is done in the ACK frame reception time. If the judgment is that it is an ACK reception (Yes in step Sb12), return is made to step Sa5, and the carrier sensor 12 waits for reception. If the judgment is that it is not ACK reception (No in step Sb12), processing proceeds to step Sa13, and the carrier sensor 12 judges whether or not receiving level detection has ended. In step Sb20, the ACK timer 23 starts counting. In step Sb21, the judgment is that the immediately previous signal detection is in the ACK frame reception time.

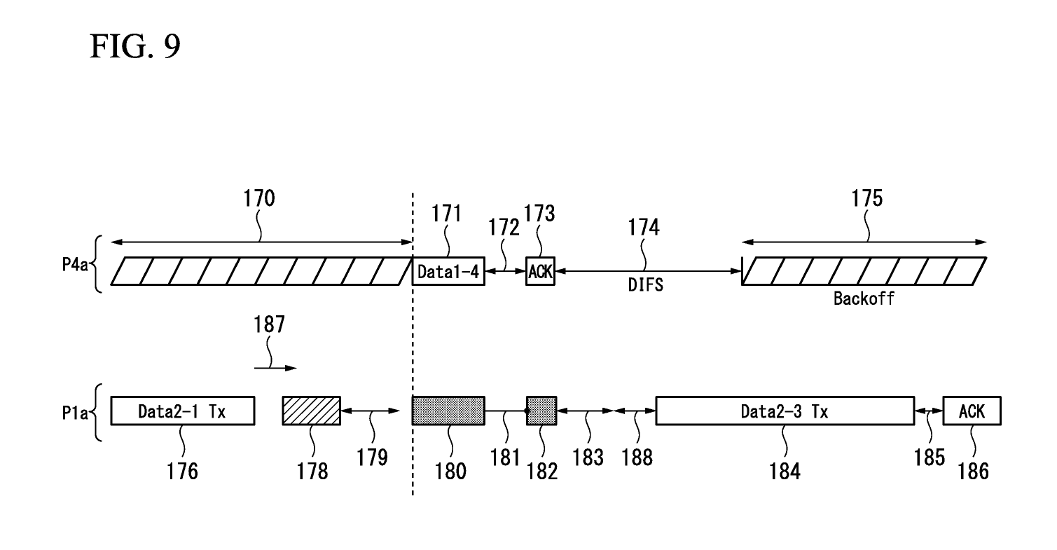

FIG. 9 is a timing chart of the processing for the wireless communication apparatus 1 transmitting a Data frame when the positional relationship is Case B. The upper part of FIG. 9 shows the operation P4a of the wireless communication apparatus 4, and the lower part of FIG. 9 shows the operation P1a of the wireless communication apparatus 1. During the random backoff 170 performed by the wireless communication apparatus 4, the wireless communication apparatus 1 transmits the Data 2-1 frame 176 and causes the ACK timer 23 to operate (187). Because a signal is detected before the ACK timer 23 times out (178), the wireless communication apparatus 1 judges that the detected signal is the ACK with respect to the transmitted Data 2-1 frame. In this case, however, the signal exhibits a CRC error due to fading or the like.

After the end of received signal level detection (178) of this signal, carrier sensing detects Idle (179) for the time T0. However, because the wireless communication apparatus 1 treats the signal detected at 178 as an mmFlash ACK, the wireless communication apparatus 1 does not transmit a Data frame. The wireless communication apparatus 4 transmits the Data 1-4 frame (171) after the random backoff 170 and, after the elapse of the SIFS time 172, the wireless communication apparatus 4 receives ACK (173). Because there is no signal format compatibility between mmFlash and wireless LAN, the Data 1-4 frame and ACK result in CRC errors at the wireless communication apparatus 1 (180 and 182, respectively).

The wireless communication apparatus 1 performs carrier sensing (181) from the timing of the ending of the detection of the Data 1-4 frame which had a CRC error. Before detecting Idle continuously for the predetermined time T0, the wireless communication apparatus 1 detects Busy (182) caused by the ACK transmitted at 173. The wireless communication apparatus 1 performs carrier sensing (183) from the timing of the ending of detecting the ACK frame which had a CRC error. The wireless communication apparatus 1 detects carrier Idle continuously during the predetermined time T0. For this reason, the wireless communication apparatus 1 switches to the transmitting mode (188) and transmits the Data 2-3 frame (184). After transmitting the Data 2-3 frame, and after the elapse of the SIFS time 185, the wireless communication apparatus 1 receives the ACK frame (186). In contrast, after receiving the ACK frame (173), and after waiting the DIFS time (174), the wireless communication apparatus 4 performs a random backoff 175.

In this manner, even if the judgment by the receiver 22 is of a signal other than an mmFlash signal, the transmission timing instructor 16a treats a signal received at the timing of the transmission of a response to the signal transmitted by the transmitter 17 as an mmFlash signal. This enables suppression of judgment of an ACK frame as a signal other than an mmFlash signal, even if there is an error when receiving an ACK frame in mmFlash.

### Third Embodiment

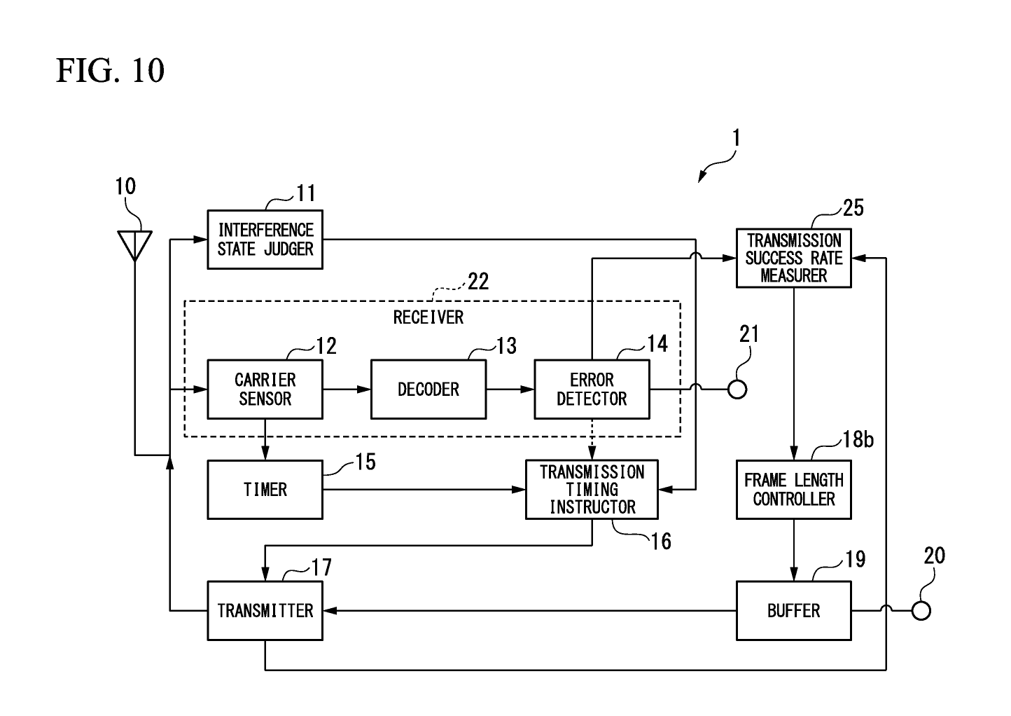

The wireless communication apparatuses 1 and 2 in the third embodiment have substantially the same constitution as the wireless communication apparatuses 1 and 2 in the first embodiment, but are partially different. In the following, the part that is different from the first embodiment will be described. FIG. 10 is a block diagram showing an example of the general constitution of the wireless communication apparatus 1 in the present embodiment. In this drawing, parts that correspond to those in FIG. 2 are assigned the same reference numerals (10 to 17 and 19 to 22), and the descriptions thereof will be omitted. The wireless communication apparatus 1 in the present embodiment differs from the wireless communication apparatus 1 in the first embodiment with regard to having a transmission success rate measurer 25 and with regard to having a frame length controller 18b in place of the frame length controller 18.

The transmission success rate measurer 25 measures the data frame transmission success rate by dividing the number of ACK frames in which the error detector 14 does not detect an error by the number of data frame transmissions by the transmitter 17.

When the transmission success rate measured by the transmission success rate measurer 25 is lower than a lower limit value, the frame length controller 18b makes the frame time length set into the buffer 19 lower than the current value. When the transmission success rate measured by the transmission success rate measurer 25 is higher than an upper limit value, the frame length controller 18b makes the frame time length set into the buffer 19 higher than the current value. Either both an upper and lower limit value or one thereof may be set with respect to the frame time length settable by the frame length controller 18b.

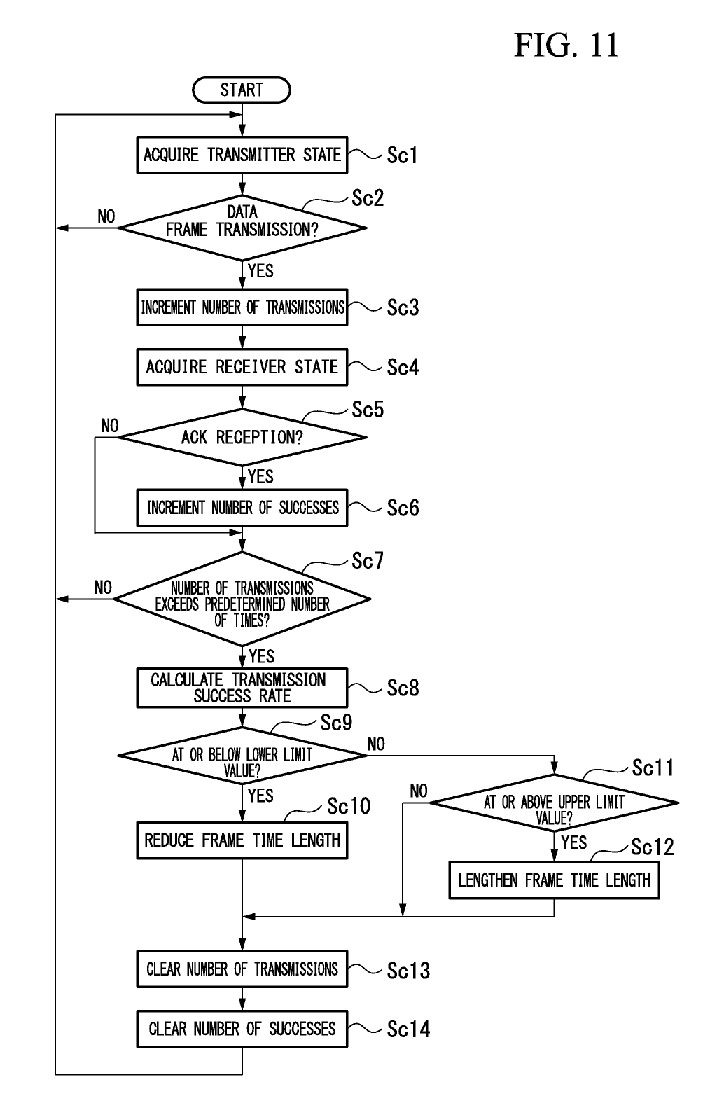

FIG. 11 is a flowchart showing an example of the processing performed by the transmission success rate measurer 25 and the frame length controller 18b. The transmission success rate measurer 25 acquires the state of the transmitter 17 from the transmitter 17 (step Sc1). If the acquired state does not indicate transmission of a data frame (No is step Sc2), processing returns to step Sc1. However, if the acquired state indicates transmission of a data frame (Yes in step Sc2), the transmission success rate measurer 25 increments the number of transmissions (step Sc3).

Next, the transmission success rate measurer 25 acquires the state of the receiver 22 from the error detector 14 (step Sc4). If the acquired state does not indicate reception of an ACK frame (No in step Sc5), processing proceeds to step Sc7. However, if the acquired state indicates reception of an ACK frame (Yes in step Sc5), the transmission success rate measurer 25 increments the number of successes (step Sc6), and processing proceeds to step Sc7.

In step Sc7, the transmission success rate measurer 25 judges whether or not the number of counted transmissions is equal to or more than a predetermined number of times. If the judgment is that the number of counted transmissions is not equal to or more than the predetermined number of times (No in step Sc7), processing returns to step Sc1. However, if the judgment is that the number of counted transmissions is equal to or more than the predetermined number of times (Yes in step Sc7), the transmission success rate measurer 25 divides the counted number of successes by the counted number of transmissions, so as to calculate the transmission success rate (step Sc8).

Next, the frame length controller 18b judges whether or not the success rate measured by the transmission success rate measurer 25 is equal to or less than a lower limit value (step Sc9). If the judgment is that the success rate is equal to or less than the lower limit value (Yes in step Sc9), the frame length controller 18b shortens the frame time length set into the buffer 19 from the current value by a predetermined amount of time (step Sc10), after which processing proceeds to step Sc13.

In step Sc9, if the judgment is that the success rate is not equal to or less than the lower limit value (No in step Sc9), the frame length controller 18b judges whether or not the success rate measured by the transmission success rate measurer 25 is equal to or more than an upper limit value (step Sc11). If the judgment is that the success rate is equal to or more than the upper limit value (Yes at Sc11), the frame length controller 18b lengthens the frame time length set into the buffer 19 from the current value by a predetermined amount of time (step Sc12), after which processing proceeds to step Sc13. In step Sc11, if the judgment is that it is equal to or more than the upper limit value (No in step Sc11), processing proceeds to step Sc13.

In step Sc13, the transmission success rate measurer 25 clears the number of transmissions and then clears the number of successes (step Sc14), after which processing returns to step Sc1.

Although, in the present embodiment, the transmission success rate measurer 25 calculates a value indicating the transmission success rate by dividing the number of ACK frames in which the error detector 14 does not detect an error by the number of data frame transmissions, a different method may be used. For example, the transmission success rate measurer 25 may calculate the transmission failure rate by dividing the number of data frame retransmissions by the number of data frame transmissions, and may use the transmission failure rate to represent the transmission success rate. The frame length controller 18b shortens the frame time length if the transmission failure rate is equal to or more than an upper limit value. Also, the frame length controller 18b lengthens the frame time length if the transmission failure rate is less than the lower limit value.

Although, in the present embodiment, the transmission success rate measurer 25 takes the transmission success rate when the number of transmissions of a data frame is equal to or more than the predetermined number of times, this can be done at some other timing, such as when a predetermined amount of time has elapsed.

The transmission success rate measurer 25 may lengthen the frame time length by multiplying the current value thereof by a predetermined expansion ratio. In the same manner, the transmission success rate measurer 25 may shorten the frame time by multiplying the current value thereof by a predetermined reduction ratio.

When lengthening the frame time length, the greater the difference between the transmission success rate and the upper limit value is, the transmission success rate measurer 25 may make the expansion ratio larger. Also, when shortening the frame time length, the greater the difference between the transmission success rate and the lower limit value is, the transmission success rate measurer 25 may make the reduction ratio larger.

In this manner, the frame length controller 18b references a value indicating the transmission success rate and changes the frame time length. This enables good effective throughput by, for example, raising the transmission success rate by shortening the frame time length when the transmission success rate is low and by lengthening the frame time length so as to increase the amount of data transmitted per frame when the transmission success rate is high.

### Fourth Embodiment

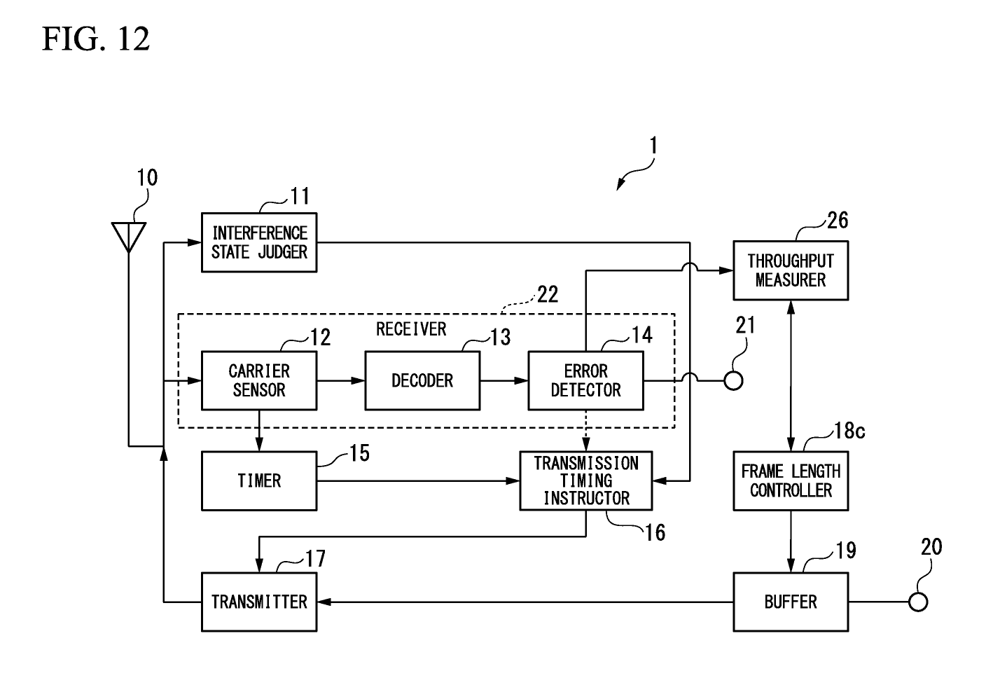

The wireless communication apparatuses 1 and 2 in the fourth embodiment have substantially the same constitution as the wireless communication apparatuses 1 and 2 in the first embodiment, but are partially different. In the following, the part that is different from the first embodiment will be described. FIG. 12 is a block diagram showing an example of the general constitution of the wireless communication apparatus 1 in the present embodiment. In this drawing, parts that correspond to those in FIG. 2 are assigned the same reference numerals (10 to 17 and 19 to 22), and the descriptions thereof will be omitted. The wireless communication apparatus 1 in the present embodiment differs from the wireless communication apparatus 1 in the first embodiment with regard to having a throughput measurer 26 and with regard to having a frame length controller 18c in place of the frame length controller 18.

The throughput measurer 26 calculates the total of the number of bits in which the error detector 14 does not detect an error in the ACK frame corresponding to the data frames transmitted by the transmitter 17. The throughput measurer 26 calculates the effective throughput by dividing the calculated total number of bits by the measurement time. The throughput measurer 26, rather than the effective throughput, may use a value indicating the effective throughput, such as a value that is the transmission success rate multiplied by the frame time length.

The frame length controller 18c references the effective throughput measured by the throughput measurer 26 and determines the frame time length. For example, when plurality of frame time length candidates are set into the buffer 19 by the frame length controller 18c, the throughput measurer 26 calculates the measured effective throughput measurement. The frame length controller 18c selects from the frame time length candidates the one that has the highest effective throughput and sets it into the buffer 19. The frame length controller 18c may determine the frame time length candidates by any method. For example, the frame length controller 18c may randomly select from a predetermined range, or may select from uniform divisions over a predetermined range. The predetermined range may be a preliminarily decided range, or may be a range in accordance with the current value of the frame time length.

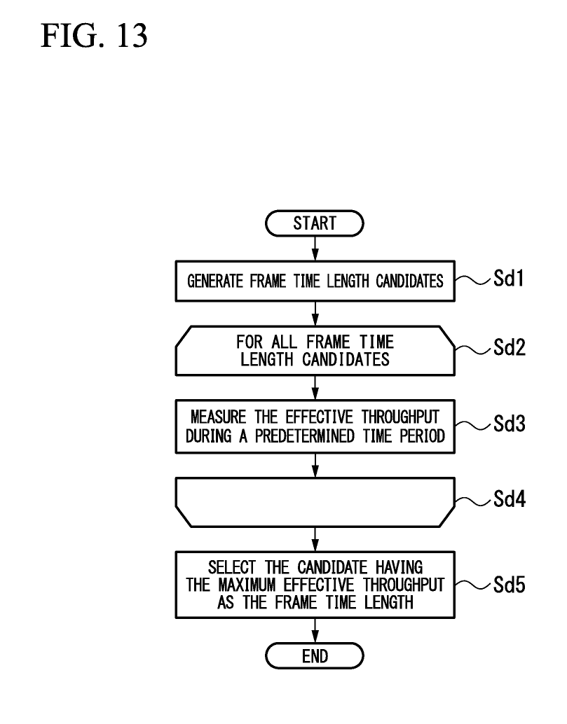

FIG. 13 is a flowchart showing an example of the processing by the frame length controller 18c and the throughput measurer 26. First, the frame length controller 18c generates a plurality of frame time length candidates (step Sd1). Next, the frame length controller 18c performs the processing of step Sd3 for all the frame time length candidates (steps Sd2 and Sd4), after which processing proceeds to step Sd5.

In step Sd3, the frame length controller 18c sets the target candidates into the buffer 19 and causes the throughput measurer 26 to measure the effective throughput over a predetermined period of time.

In step Sd5, the frame length controller 18c selects and sets into the buffer 19 the candidate that had the highest effective throughput measured in step Sd3.

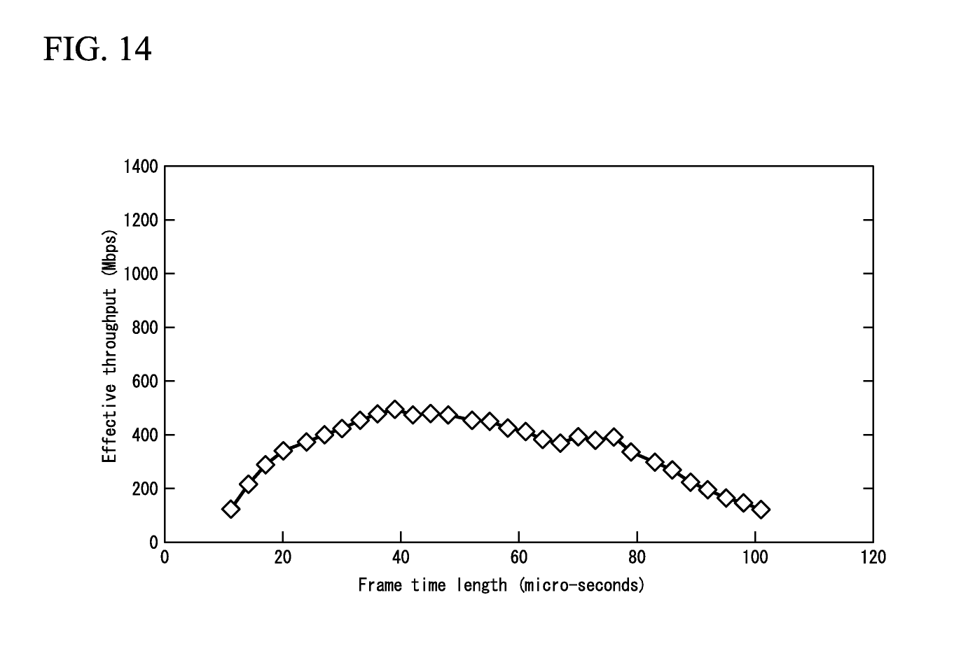

FIG. 14 is a graph showing an example of the relationship between the frame time length and the effective throughput. Because the relationship between the frame time length and the effective throughput changes in accordance with the wireless LAN usage state, the graph of FIG. 14 is one example. In FIG. 14, the horizontal axis represents the frame time length (micro-seconds), and the vertical axis represents the effective throughput (Mbps). In the example shown in FIG. 14, in the region in which the frame time length is 40 micro-seconds, the effective throughput is a maximum value of approximately 500 Mbps. In this example, therefore, the frame length controller 18c can obtain a good effective throughput by making the frame time length 40 micro-seconds.

Although in this embodiment the frame length controller 18c determines the frame time length from a plurality of frame time length candidates, a different method may be used to determine the frame time length. For example, the frame length controller 18c may try changing the frame time length from the current value and, if the result of measuring the effective throughput is an improvement, it maintains the change, but if there is not an improvement, it returns to the original value.

In this manner, the frame length controller 18c references a value indicating the effective throughput measured by the throughput measurer 26 to determine the frame time length. This enables the achievement of a good effective throughput.

### Fifth Embodiment

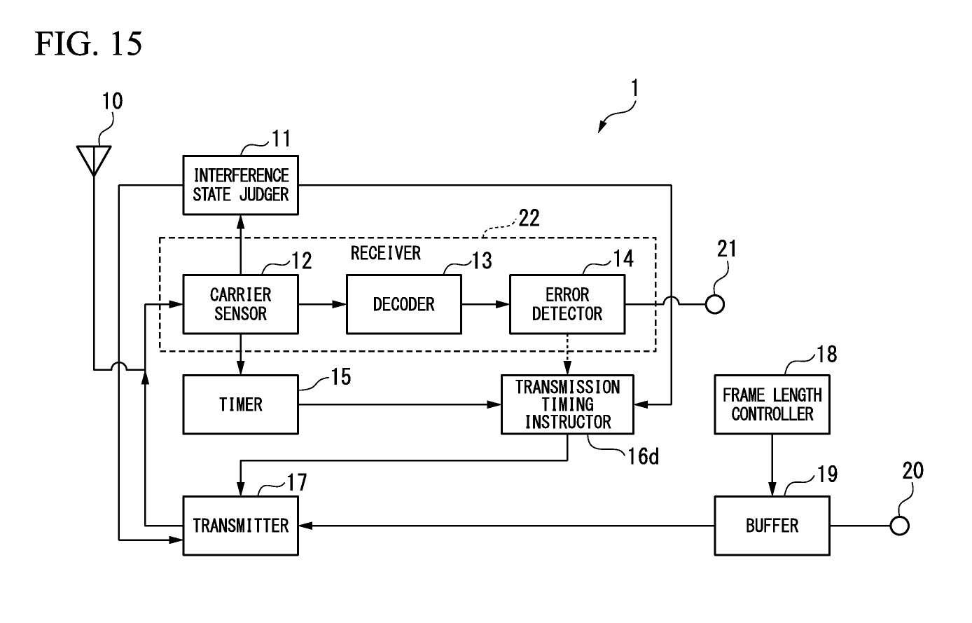

The wireless communication apparatuses 1 and 2 in the fifth embodiment have substantially the same constitution as the wireless communication apparatuses 1 and 2 in the first embodiment, but are partially different. In the following, the part that is different from the first embodiment will be described. FIG. 15 is a block diagram showing an example of the general constitution of the wireless communication apparatus 1 in the present embodiment. In this drawing, parts that correspond to those in FIG. 2 are assigned the same reference numerals (10 to 15 and 17 to 22), and the descriptions thereof will be omitted. The wireless communication apparatus 1 in the present embodiment differs from the wireless communication apparatus 1 in the first embodiment with regard to having a transmission timing instructor 16d in place of the transmission timing instructor 16.

Similar to the transmission timing instructor 16 of the first embodiment, the data transmission timing instructor 16d instructs the transmitter 17 of the transmission timing when the interference state judger 11 judges that the case is either Case B or Case C. The transmission timing of the instruction is the time from the detection of a signal other than an mmFlash signal until the carrier sensor 12 does not detect a signal over the predetermined time TO. However, when the ACK frame with respect to a transmitted data frame is received, the transmission timing instructor 16d causes the transmitter 17 to continue and transmit the next data frame.

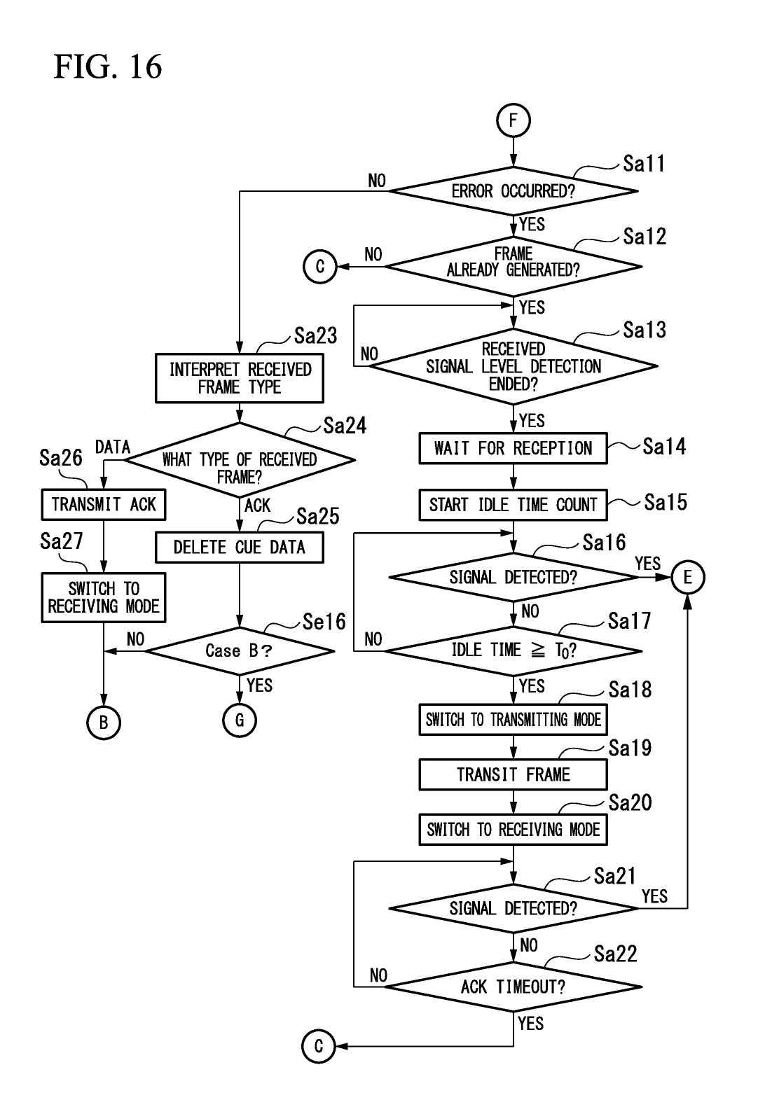

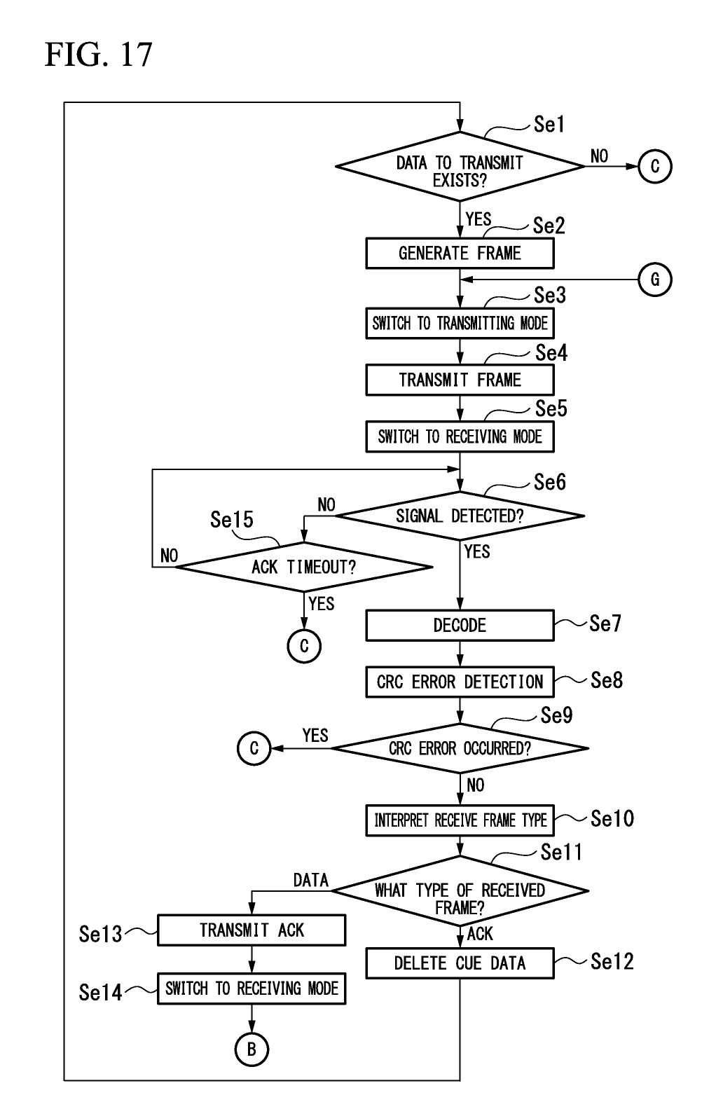

FIG. 16 and FIG. 17 are flowcharts showing an example of the operation of the wireless communication apparatus 1 in the present embodiment. The flowcharts in the present embodiment differ from the flowcharts of FIG. 3 to FIG. 5 with regard to the inclusion of steps Se1 to Se16. FIG. 16 and FIG. 17 show only the parts of the flowcharts for the present embodiment that include parts that differ from FIG. 3 to FIG. 5.

In step Sa25, after deletion of queue data from the buffer 19, the transmission timing instructor 16d judges whether or not the interference state judgment by the interference state judger 11 is Case B (step Se16). If the judgment is that it is not Case

B (No in step Se16), processing returns to step Sa3. However, if the judgment in step Se16 is that it is Case B (Yes in step Se16), the transmitter 17 and the carrier sensor 12 switch to the transmitting mode (step Se3). After completion of the switch to the transmitting mode, the transmitter 17 transmits the frame that is stored in the queue (step Se4).

When the frame transmission is completed, the transmitter 17 and the carrier sensor 12 switch to the receiving mode (step Se5). When the switch to the receiving mode is completed, the carrier sensor 12 starts to wait for reception, and the carrier sensor 12 judges whether or not a signal is detected (step Se6). If a judgment is made that a signal is detected (Yes in step Se6), the decoder 13 decodes the detected signal (step Se7). After the end of the decoding, the error detector 14 performs CRC error detection with respect to the results of the decoding by the decoder 13 (step Se8). Next, the error detector 14 judges whether or not an error is detected by the CRC error detection in step Se8 (step Se9).

In step Se9, if the judgment is that an error has been detected (Yes in step Se9), processing proceeds to step Sa5. However, if the judgment in step Se9 is that an error has not been detected (No in step Se9), the error detector 14 interprets the type of frame (received frame) that is the subject of the error detection (step Se10). As a result of the interpretation, if the type of the received frame is an ACK frame (ACK in step Se11), the buffer 19 deletes from the queue the last frame transmitted (step Se12), and then judges whether or not data to be transmitted is stored (step Se1).

If the judgment is that data to be transmitted is not stored (No in step Se1), processing proceeds to step Sa5. However, if the judgment in step Se1 is that data to be transmitted is stored (Yes in step Se1), the buffer 19 generates a frame and stores the generated frame in the queue (step Se2), after which processing proceeds to step Se3.

However, if the result of the interpretation in step Se10 is that the type of the received frame is a data frame (Data in step Se11), the transmitter 17 transmits an ACK frame (step Se13). When the transmission of the ACK frame is completed, the transmitter 17 and the carrier sensor 12 switch to the receiving mode (step Se14), after which processing returns to step Sa3.

In step Se6, if the judgment is that a signal is not detected (No in step Se6), a judgment is made as to whether or not the ACK timer has timed out (step Se15). If the judgment is that it had not timed out (No in step Se15), processing returns to step Se6. The ACK timer times out by the time from the completion of the transmission of the frame by the transmitter 17 until the transmission of an ACK frame with respect to the frame received by the wireless communication apparatus 2. However, if the judgment in step Se15 is that timeout has occurred, processing returns to step Sa5.

In this manner, when the interference state judger 11 judges that wireless LAN is not being interfered with, the transmission timing instructor 16d causes the transmitter 17 to continue and transmit a frame when the receiver 22 receives an ACK frame with respect to the transmitted frame. This enables the achievement of a good effective throughput. Because continuous frame transmission is stopped when the positional relationship is such that wireless LAN is interfered with, it is possible to suppress the probability of continuous interference with wireless LAN.

Although the wireless communication apparatuses 4 and 5 communicate by wireless LAN in the various above-noted embodiments, they may use another wireless communication scheme, as long as it uses a frequency band that overlaps with the wireless communication scheme used by the wireless communication apparatuses 1 and 2 (mmFlash) and also is a CSMA/CA (carrier sense multiple access with collision avoidance) wireless communication scheme.

Although in the various above-noted embodiments the wireless communication apparatuses 1 and 2 communicate using mmFlash, they may use another wireless communication scheme, as long as it uses a frequency band that overlaps with the wireless communication scheme used by the wireless communication apparatuses 4 and 5.

Although in the various above-noted embodiments the error detector 14 treated a frame signal in which a CRC error is detected as being a signal other than an mmFlash (registered trademark) signal, this is not a restriction. For example, the header or the like of the decoded frame may be referenced to judge whether or not the frame is an mmFlash frame.

According to at least one of the above-described embodiments, the wireless communication apparatus 1 has a transmission timing instructor 16 instructing the transmitter 17 to transmit a signal by using the mmFlash if the receiver 22 does not receive a signal over the predetermined time TO from a detection of a signal other than a signal transmitted by using the mmFlash, thereby enabling suppression interference to the transmission by the transmitter 17 from a response of a different wireless communication scheme, which would reduce the communication efficiency.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a transmitter that transmits a signal by using a first wireless communication scheme;
a receiver that receives a signal transmitted by using the first wireless communication scheme, and the receiver detecting a signal of which a frequency band includes at least a part of a frequency band used in the first wireless communication scheme, which is other than a signal transmitted by using the first wireless communication scheme; and
a transmission timing instructor that instructs the transmitter to transmit a signal by using the first wireless communication scheme if the receiver does not receive a signal over a predetermined time from a detection of a signal other than a signal transmitted by using the first wireless communication scheme.

2. The wireless communication apparatus according to claim 1, wherein the predetermined time is equal to or more than a time from receiving a signal to transmitting a response in a second wireless communication scheme, the second wireless communication scheme using a frequency band includes at least a part of a frequency band used in the first wireless communication scheme.

3. The wireless communication apparatus according to claim 2, further comprising:
a frame length controller that determines frame time length of the signal transmitted by the transmitter, the frame time length being a value in accordance with a maximum value of the backoff time in the second wireless communication scheme.

4. The wireless communication apparatus according to claim 3, wherein the frame length controller determines the frame time length so that, after the transmitter transmits a frame, a time when a transmission of a response with respect to the frame is completed by another wireless communication apparatus is before a time corresponding to the maximum value of the backoff time.

5. The wireless communication apparatus according to claim 1, further comprising:
a transmission success rate measurer that calculates a value indicating transmission success rate of frames transmitted by the transmitter; and
a frame length controller that changes frame time length of the signal transmitted by the transmitter with reference to the value indicating the transmission success rate.

6. The wireless communication apparatus according to claim 1, further comprising:
a throughput measurer that calculates a value indicating effective throughput of transmission performed by the transmitter; and
a frame length controller that determines frame time length of the signal transmitted by the transmitter with reference to the value indicating the effective throughput.

7. The wireless communication apparatus according to claim I, further comprising:
an interference state judger that judges whether or not the signal from the wireless communication apparatus interferes with another wireless communication apparatus communicating by using a second wireless communication scheme, the second wireless communication scheme using a frequency band includes at least a part of a frequency band used in the first wireless communication scheme,
wherein when the interference state judger judges that the signal from the wireless communication apparatus does not interfere with the another wireless communication apparatus, the transmission timing instructor causes the transmitter to continue and transmit a next data frame.

8. The wireless communication apparatus according to claim 1, wherein even if judgment by the receiver is of a signal other than a signal transmitted by using the first wireless communication scheme, the transmission timing instructor treats a signal received at a timing of a transmission of a response to the signal transmitted by the transmitter as a signal of the first wireless communication scheme.

9. The wireless communication apparatus according to claim 1, wherein the predetermined time is different from a value of another wireless communication apparatus communicating by using the first wireless communication scheme.

10. A wireless communication method transmitting a signal by using a first wireless communication scheme in a wireless communication apparatus, comprising:
detecting a signal of which a frequency band includes at least a part of a frequency band used in the first wireless communication scheme, which is other than a signal transmitted by using the first wireless communication scheme; and
transmitting a signal by using the first wireless communication scheme if a signal is not detected over a predetermined time from a detection of the signal other than a signal transmitted by using the first wireless communication scheme.

11. The wireless communication method according to claim 10, wherein the predetermined time is equal to or more than a time from receiving a signal to transmitting a response in a second wireless communication scheme, the second wireless communication scheme using a frequency band includes at least a part of a frequency band used in the first wireless communication scheme.

12. The wireless communication method according to claim 11, further comprising:
determining frame time length of the transmitted signal, the frame time length being a value in accordance with a maximum value of the backoff time in the second wireless communication scheme.

13. The wireless communication method according to claim 12, wherein the frame time length is determined so that, after transmitting a frame, a time when a transmission of a response with respect to the frame is completed by another wireless communication apparatus is before a time corresponding to the maximum value of the backoff time.

14. The wireless communication method according to claim 10, further comprising:
calculating a value indicating transmission success rate of transmitted frames; and
changing frame time length of the transmitted signal with reference to the value indicating the transmission success rate.

15. The wireless communication method according to claim 10, further comprising:
calculating a value indicating effective throughput of transmission; and
determining frame time length of the transmitted signal with reference to the value indicating the effective throughput.

16. The wireless communication method according to claim 10, further comprising:
judging whether or not the signal from the wireless communication apparatus interferes with another wireless communication apparatus communicating by using a second wireless communication scheme, the second wireless communication scheme using a frequency band includes at least a part of a frequency band used in the first wireless communication scheme,
wherein when it is judged that the signal from the wireless communication apparatus does not interfere with the another wireless communication apparatus, a next data frame is transmitted.

17. The wireless communication method according to claim 10, wherein even if judgment is of a signal other than a signal transmitted by using the first wireless communication scheme, a signal received at a timing of a transmission of a response to the transmitted signal is treated as a signal of the first wireless communication scheme.

18. The wireless communication method according to claim 10, wherein the predetermined time is different from a value of another wireless communication apparatus communicating by using the first wireless communication scheme.

19. A wireless communication method transmitting a signal by using a first wireless communication scheme in a wireless communication system including a first wireless communication apparatus and a second wireless communication apparatus, the second wireless communication apparatus wirelessly communicating with the first wireless communication apparatus by using the first wireless communication scheme, comprising:
transmitting a signal by using the first wireless communication scheme;
receiving a signal transmitted by using the first wireless communication scheme;
detecting a signal of which a frequency band includes at least a part of a frequency band used in the first wireless communication scheme, which is other than a signal transmitted by using the first wireless communication scheme; and
transmitting a signal by using the first wireless communication scheme if a signal is not detected over a predetermined time from a detection of the signal other than a signal transmitted by using the first wireless communication scheme.

20. The wireless communication method according to claim 19, wherein the predetermined time is equal to or more than a time from receiving a signal to transmitting a response in a second wireless communication scheme, the second wireless communication scheme using a frequency band includes at least a part of a frequency band used in the first wireless communication scheme.
